(19) United States
(12) Patent Application Publication
(10) Pub. No.: US 2012/0176386 A1
(43) Pub. Date: Jul. 12, 2012

(54) REDUCING RECURRENT COMPUTATION COST IN A DATA PROCESSING PIPELINE

(76) Inventor: Edward A. Hutchins, Mountain View, CA (US)

(21) Appl. No.: 13/346,364

(22) Filed: Jan. 9, 2012

Related U.S. Application Data
(60) Provisional application No. 61/460,947, filed on Jan. 10, 2011.

(51) Int. Cl. G06T 1/00

(52) U.S. Cl. 345/522; 345/501

(57) ABSTRACT

Briefly, in accordance with one or more embodiments of graphics processing, a current data signature is generated based at least in part on current input data, and the current data signature is compared with a prior cycle data signature. If the current data signature at least partially matches the prior cycle data signature, a prior cycle result may be fetched and processing of at least part of the current input data may be skipped.

### CROSS-REFERENCE TO RELATED APPLICATIONS

The present application claims the benefit of Provisional Application No. 61/460,947 filed Jan. 10, 2011. Said Application No. is hereby incorporated herein in its entirety.

### BACKGROUND

Embodiments of the present subject matter relate to reducing computational costs in data processors designed to perform recurrent or cyclical data processing. More specifically, embodiments of the present subject matter relate to reducing the bandwidth and computational requirements of computer graphic image rendering processors.

In a broad class of data processing applications, similar processing operations recur with potentially identical results. Such applications include processing of streaming video data, 2D and 3D graphics rendering, image processing, and general streaming computations. Such applications are marked by a cyclical nature such as the processing of an input stream delimited by cyclical output result boundaries. The processing cost of these applications may be very high. Any technique which reduces overall computation cost may be beneficial to the overall utility of the processing apparatus, system or method. In processes where identical inputs produce identical outputs, reusing the results from a prior cycle can avoid some or all of the work in the current cycle.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a flow diagram illustrating a typical recurrent computation in accordance with one or more embodiments;

FIG. 2 is a diagram depicting a typical recurrent computation's data structures in accordance with one or more embodiments;

FIG. 3 is a flow diagram illustrating an example optimized embodiment of recurrent computation in accordance with one or more embodiments;

FIG. 4 is a diagram depicting a block subdivision recurrent computation's data structures in accordance with one or more embodiments;

FIG. 5 is a flow diagram illustrating an example optimized embodiment of recurrent computation with block subdivision in accordance with one or more embodiments;

FIG. 6 is a diagram depicting a block and step subdivision recurrent computation's data structures in accordance with one or more embodiments;

FIG. 7 is a flow diagram illustrating an example optimized embodiment recurrent computation with block and step subdivision in accordance with one or more embodiments;

FIG. 8 is a diagram depicting an example of combined static and dynamic signature generation data flow recurrent computation in accordance with one or more embodiments;

FIG. 9 is a flow diagram illustrating a process of combing static and dynamic signatures with recurrent computation in accordance with one or more embodiments;

FIG. 10 is a diagram depicting an image subdivided by a regular rectangular tiling, and a corresponding tile buffer memory in accordance with one or more embodiments;

FIG. 11 is a block diagram of a tiling-based graphics processing engine in accordance with one or more embodiments;

FIG. 12 is a diagram depicting an image subdivided by a regular rectangular tiling, a corresponding tile buffer memory, and a corresponding signature memory for example optimized embodiments of a graphics processor in accordance with one or more embodiments;

FIG. 13 is a block diagram of an example optimized embodiment of a tiling-based graphics processing engine in accordance with one or more embodiments;

FIG. 14 is a flow diagram illustrating the operation of an example optimized embodiment of a tiling-based graphics processing binning processor in accordance with one or more embodiments;

FIG. 15 is a flow diagram illustrating the operation of an example optimized embodiment of a tiling-based graphics processing pixel rasterizer in accordance with one or more embodiments;

FIG. 16 is a diagram depicting a combination of dynamic and static signatures into a master signature for a graphics command sequence utilized by an example graphics processor in accordance with one or more embodiments;

FIG. 17 is a block diagram of an information handling system capable of reducing recurrent computation cost in a data processing pipeline in accordance with one or more embodiments; and

FIG. 18 is an isometric view of an information handling system of FIG. 17 that optionally may include a touch screen in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other. Furthermore, any operation, process, step, function, block, or module, and so on, described herein may be tangibly embodied in hardware including any appropriate circuit or circuits, or alternatively may be embodied as software stored in a non-transient storage medium wherein the instructions may executed by a machine or suitable hardware, and/or any combination of hardware and software.

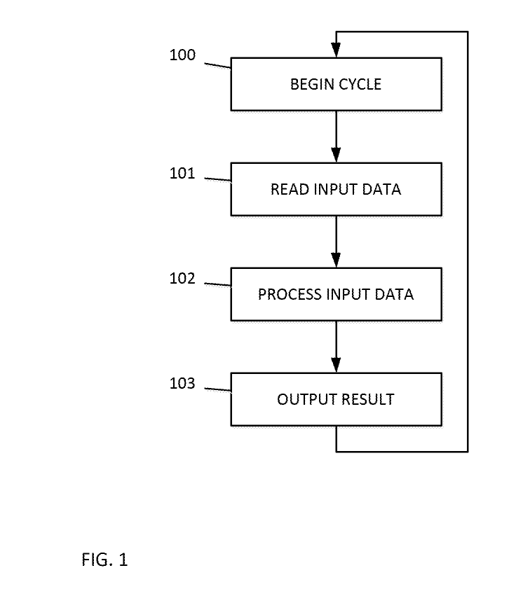

Referring now to FIG. 1, a flow diagram illustrating a typical recurrent computation in accordance with one or more embodiments will be discussed. An example recurrent processing pipeline consists of a loop which generates an input to the processing unit, which in turn generates a result for each input as shown in FIG. 1. Recurrent processing can be broadly characterized as having cycles which perform identical operations on inputs and produce outputs uniquely defined by those inputs only. In FIG. 1 such operations are shown as separate units for clarity though typical embodiments may inter-mix operations or perform operations in parallel or pipelined order as dictated by the particular application or embodiment. In addition, data inputs and outputs are exemplified by, but not limited to, computer communications, storage or memory. Any data source or sink in a computational system may be employed as needed by the particular application or embodiment.

It is assumed that the loop shown in FIG. 1 is entered at the beginning of the cycle 100 and exited after a final cycle 103, and these entry and exit points have been omitted from the drawing for clarity. Each cycle may begin with an optional input-invariant processing operation 100, for example to initialize or modify iteration variables or perform other input-independent processing. Next, one or more inputs 101 are read from external computer communications, storage, or memory or any other form of input data source in common use. Reading inputs may include allocation of buffers or other storage for said input data. One or more input-dependent processing operations 102 are then performed, producing a result. Results may then optionally be output 103, for example by being written back to external computer communications, storage or memory destinations. Variations of the above processing operations wherein operations are performed conditionally based on intermediate state are also possible. Embedding the recurrent processing pipeline of FIG. 1 into a larger processing apparatus and determining under which conditions processing cycles begin and end may use any method available to someone skilled in the art without substantial change to the scope or usefulness of the embodiment, and the scope of the claimed subject matter is not limited in these respects.

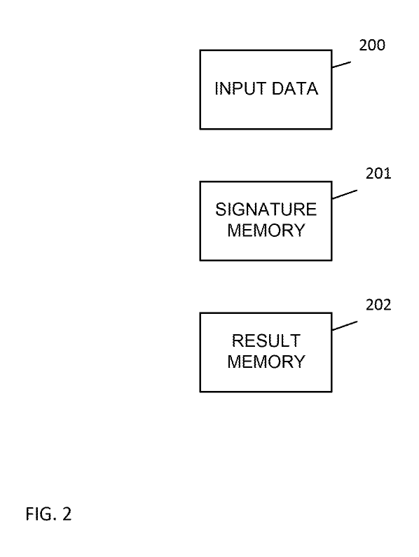

Referring now to FIG. 2, a diagram depicting a typical recurrent computation's data structures in accordance with one or more embodiments will be discussed. In cases where identical inputs produce identical outputs and the result of an identical prior computation is available in some form (such as a memory buffer), a general embodiment of the claimed subject matter marks the input buffer with an identifying digital signature, detects a prior identical input signature, and substitutes the result of the matching prior processing cycle in place of performing the identical processing operations on the current input. A digital signature (or just signature) herein refers to any process of generating a smaller numeric identifier from an arbitrarily large data set such that the large data set can be represented by said signature for identification purposes with low probability of collision with similarly computed signatures from other data sets. FIG. 2 depicts an example memory organization for a general embodiment of the claimed subject matter. In this example, a processing cycle utilizes input data 200, signature memory 201, and result memory 202 during processing. These memories may be logical partitions of a larger main memory, separate memories, or otherwise stored or communicated for access by the recurrent computation.

Such a technique entails additional storage and comparison logic for the signatures. Note it may not be possible to generate unique signatures for all possible input data, resulting in signature collisions and a resulting erroneous substitution of a prior result. In practice this limitation may be tolerable, for example if the error rate can be reduced below the device error rate cause by alpha-particle strikes. Collision rates for signature generation techniques are known and may be used to determine the appropriate signature size for any acceptable false positive rate based on input data size and data value distribution, and the scope of the claimed subject matter is not limited in these respects.

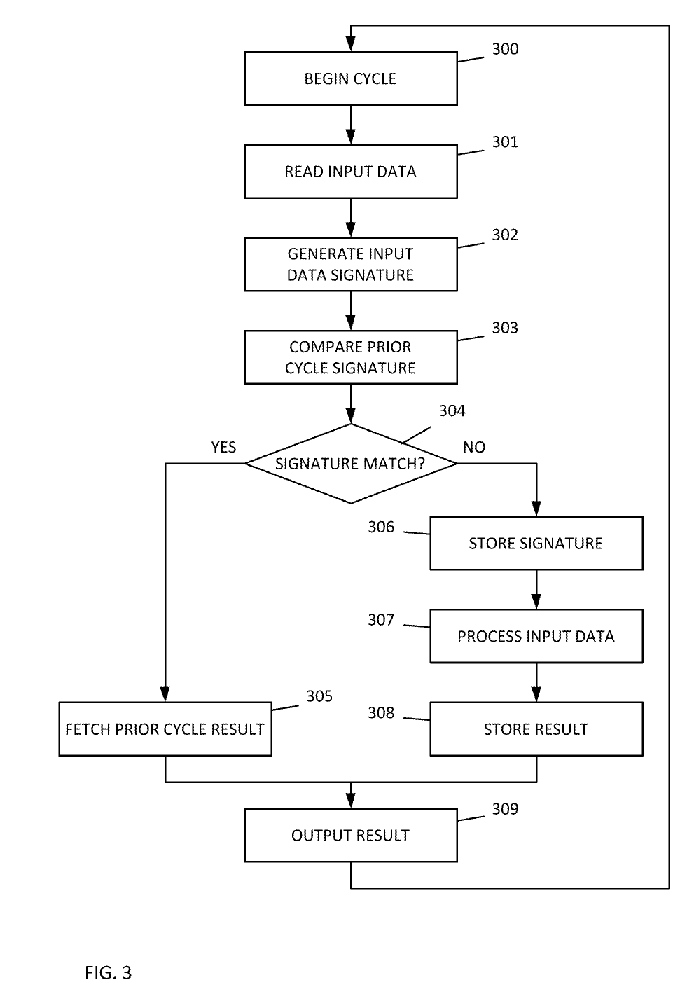

Referring now to FIG. 3, a flow diagram illustrating an example optimized embodiment of recurrent computation in accordance with one or more embodiments will be discussed. The method of FIG. 3 illustrates one particular embodiment of recurrent computation. However, in one or more alternative embodiments, various other orders of the blocks of the method of FIG. 3 may be implemented, with more or fewer blocks, and the scope of the claimed subject matter is not limited in this respect. It is assumed that the loop shown in FIG. 3 is entered at the beginning of the cycle 300 and exited after a final cycle 309, these entry and exit points have been omitted from the drawing for clarity. The cycle consists of domain-specific input invariant processing for each iteration 300. Next, one or more inputs 301 read from external computer communications, storage, or memory as depicted in FIG. 1. At this point a signature is generated 302 for the processing cycle's input data. Signature generation can be performed using any method in common practice, wherein examples include but are not limited to simple summation with overflow or exclusive-OR logical combination of input data words, MD5 check-summing, or other data hashing function, and the scope of the claimed subject matter is not limited in these respects. One or more prior signatures stored during prior processing cycles are fetched from external computer communications, storage, or memory and compared against the corresponding current signature or signatures 303 using any technique in standard practice, including but not limited to hash table look-up, associative memory or comparison against a single prior cycle's signature. Subsequent processing operations are then selected based on the result of the comparison 304. If a signature matches, the corresponding prior result is fetched from external computer communications, storage, or memory 305, the below described processing operations 306, 307 and 308 are skipped, and the associated computational costs are saved. If no match is found, the current signature is stored in external computer communications, storage, or memory 306, the current cycle's processing is performed 307, and the result stored 308 in external computer communications, storage, or memory for use by future processing cycles. In alternate embodiments of the claimed subject matter, the output signature may be stored concurrently with or subsequent to output result storage. Once the above signature decision is complete, the result is output to whatever subsequent processing operations the particular embodiment requires 309. At this point the next processing cycle begins 300 if further cycles of input data are available. Embedding the recurrent processing pipeline of FIG. 3 into a larger processing apparatus and determining under which conditions processing cycles begin and end may use any method available to someone skilled in the art without substantial change to the scope or usefulness of the embodiment, and the scope of the claimed subject matter is not limited in these respects.

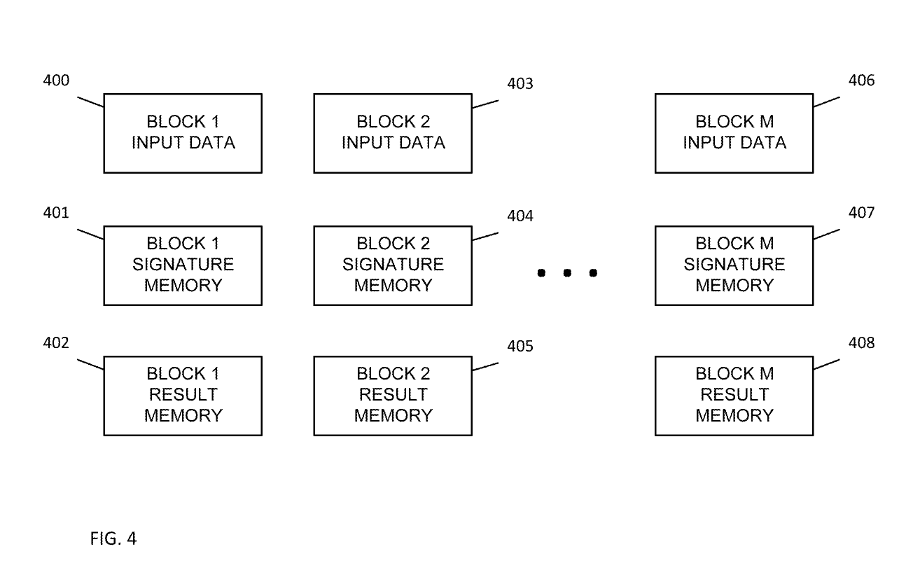

Referring now to FIG. 4, a diagram depicting a block subdivision recurrent computation's data structures in accordance with one or more embodiments will be discussed. In practice, the frequency of identical signatures may be low for typical inputs when a processing cycle is viewed as a whole due to the high probability of some portion of input changing between cycles. In this case, techniques for subdividing the processing cycle, for example by screen regions, units of time, or other logical partitions, may be employed in order to find smaller occurrences of identical processing within the larger input cycle. The input data is thereby partitioned into independent blocks of data subdivided from the original input stream by whatever technique is appropriate for the desired application or embodiment. This subdivision may include replication or omission of the original input data where such replication or omission is advantageous. Depending on the nature of the processing being performed, the input stream subdivision and signature generation may be embodied using different techniques appropriate to the problem domain. FIG. 4 depicts the memory organization for an example subdivision embodiment. Input data is divided into blocks 400, 403, 406, signatures are stored in per-block memories 401, 404, 407, and block results are stored in result memories 402, 405 and 408. These memories may be logical partitions of a larger main memory, separate memories, or otherwise stored or communicated for access by the recurrent computation. This organization is an example descriptive of the various parts and in no way limits the potential organizations for the claimed subject matter, and the scope of the claimed subject matter is not limited in these respects.

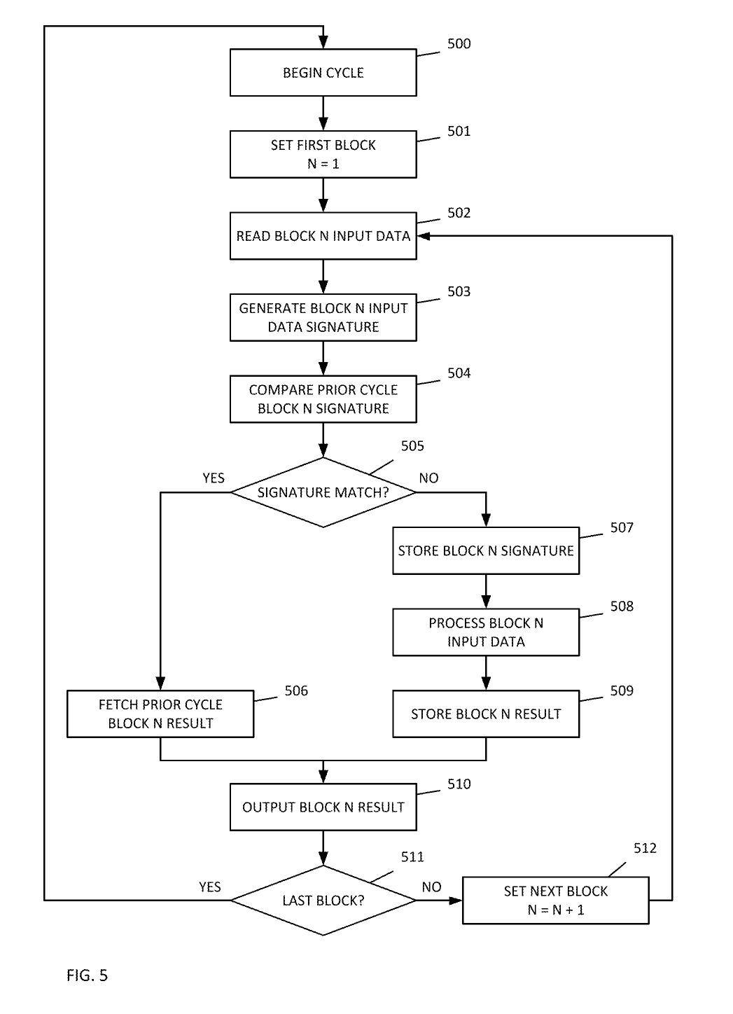

Referring now to FIG. 5, a flow diagram illustrating an example of recurrent computation with block subdivision in accordance with one or more embodiments will be discussed. The method of FIG. 5 illustrates one particular embodiment of recurrent computation with block subdivision. However, in one or more alternative embodiments, various other orders of the blocks of the method of FIG. 5 may be implemented, with more or fewer blocks, and the scope of the claimed subject matter is not limited in this respect. It is assumed that the loop shown in FIG. 5 is entered at the beginning of the cycle 500 and exited after a final cycle 511, and these entry and exit points have been omitted from the drawing for clarity. Details concerning the embodiment each functional unit are as described in the corresponding units illustrated in FIG. 3. First, input invariant processing 500 is performed for each cycle. Per-block operation begins with an iterator N initialized to the first block to be processed 501. While this example embodiment iterates through the subdivided blocks in linear order, any traversal mechanism may be employed without substantially changing the embodiment. For each block, one or more block inputs 502 are read from external computer communications, storage, or memory as depicted in FIG. 4. At this point, a signature is generated 503 for the block's input data. One or more prior signatures stored during prior block processing iterations from prior processing cycles are fetched from external computer communications, storage, or memory and compared against the corresponding current signature or signatures 504, for example using any technique in standard practice. In typical embodiments, the block at the identical subdivision sequence or iteration index from the immediately prior cycle is the target of the signature check, but any block signature may be checked as dictated by the application domain or embodiment, including prior blocks from the current cycle if such blocks are likely to match signatures with the current block being processed. Subsequent processing operations are then selected based on the result of the comparison 505. If a signature matches, the corresponding prior block's result is fetched from external computer communications, storage, or memory 506, the below described processing operations 507, 508 and 509 are skipped and the associated computational costs are saved. Candidate prior blocks may be selected from the current or prior cycle depending on the problem domain without substantially changing the embodiment. If no match is found, the current signature is stored in external computer communications, storage, or memory 507, the current block's processing is performed 508, and the result stored 509 in external computer communications, storage, or memory for use by future processing iterations. In alternate embodiments, the output signature may be stored concurrently with or subsequent to output result storage. Once the above signature decision is complete, the block result is output to whatever subsequent processing operations the particular embodiment requires 510. A comparison 511 is then performed to determine if further blocks remain to be processed for the current cycle. If blocks remain to be processed, the iterator N is incremented to select the next block 512 and operation continues starting with reading the next block 502. If no further blocks remain, the cycle is complete and the next cycle is started at 500. Embedding the example subdivision embodiment of FIG. 5 into a larger processing apparatus and determining under which conditions processing cycles begin and end may use any method available to someone skilled in the art without substantial change to the scope or usefulness of the embodiment, and the scope of the claimed subject matter is not limited in this respect.

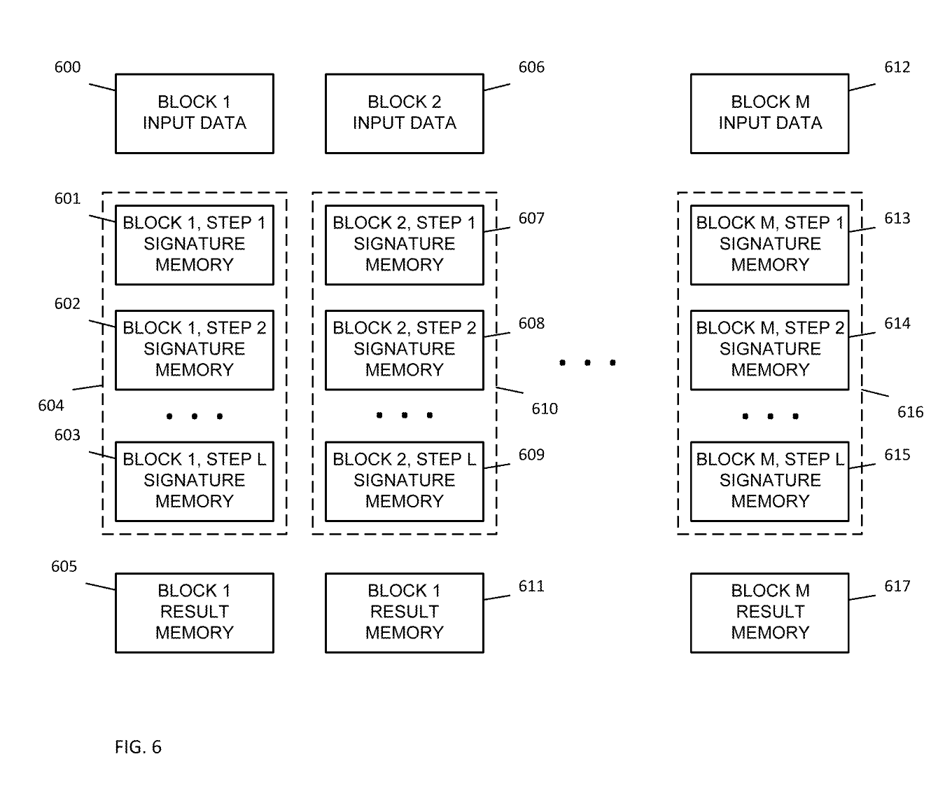

Referring now to FIG. 6, a diagram depicting a block and step subdivision recurrent computation's data structures in accordance with one or more embodiments will be discussed. In addition to partitioning the processing cycle itself, it may also be possible in some embodiments to avoid a portion of the processing cycle even though the input signature finds no matching prior result. In this variation, processing proceeds through a sequence of steps or operations, each of which may converge on a partial result and signature which indicates the remaining processing steps or operations are redundant if a matching partial signature is found. In this case, processing may be terminated and the prior result substituted before all processing steps are completed, saving the costs incurred by said processing steps. In an example embodiment of this variation, results are stored into an intermediate buffer with advantageous access costs compared to the final result destination buffer. Before updating external computer communications, storage, or memory, the signature of the intermediate buffer can be computed and compared with the signature of a prior result buffer directly, and associated result update costs may be avoided if a match is detected. FIG. 6 depicts the memory organization of another embodiment wherein the subdivided processing blocks are further subdivided into temporal processing steps or operations. Depending on the nature of the processing being performed, the temporal subdivision and signature generation may be embodied using different techniques appropriate to the problem domain. Input data is divided into blocks 600, 606, 612 as in FIG. 4. Each block has signature step memories 604, 610, 616 which are further partitioned into signatures for each respective operation (601, 602, 603, 607, 608, 609, 613, 614, and 615). Signatures for each block and operation are stored in signature memories 605, 611 and 617. These memories may be logical partitions of a larger main memory, separate memories, or otherwise stored or communicated for access by the recurrent computation. This organization is an example descriptive of the various parts and in no way limits the potential organizations for or the scope of the claimed subject matter.

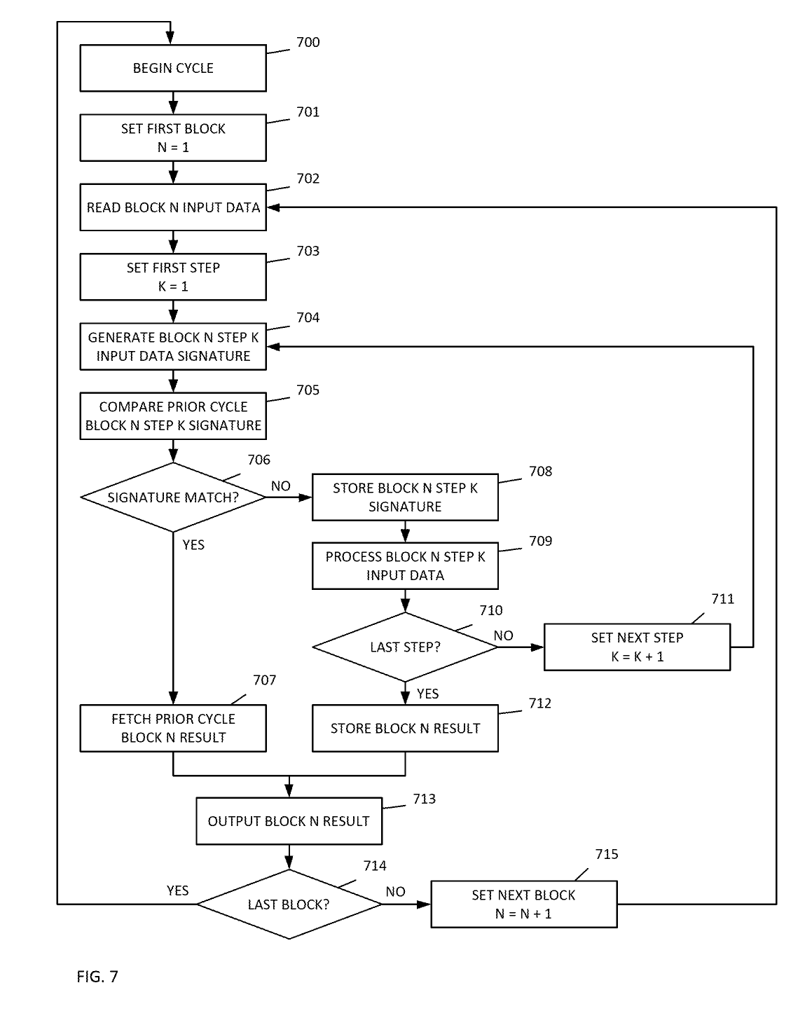

Referring now to FIG. 7, a flow diagram illustrating an example optimized embodiment recurrent computation with block and step subdivision in accordance with one or more embodiments will be discussed. The method of FIG. 7 illustrates one particular embodiment of recurrent computation with block and temporal step subdivision. However, in one or more alternative embodiments, various other orders of the blocks of the method of FIG. 7 may be implemented, with more or fewer blocks, and the scope of the claimed subject matter is not limited in this respect. It is assumed that the loop shown in FIG. 7 is entered at the beginning of the cycle 700 and exited after a final cycle 714, these entry and exit points have been omitted from the drawing for clarity. Details concerning the embodiment each functional unit are as described in the corresponding units illustrated in FIG. 5. First, input invariant processing 700 is performed for each cycle. Per-block operation begins with an iterator N initialized to the first block to be processed 701. While this example embodiment iterates through the subdivided blocks in linear order, any traversal mechanism may be employed without substantially changing the embodiment. For each block, one or more block inputs 702 are read from external computer communications, storage, or memory as depicted in FIG. 6. Next, an iterator K tracking each processing operation is initialized to the first step 703. At this point, a step signature is generated 704 for the block's input data and any intermediate data utilized in each processing operation. One or more prior signatures stored during prior block and step processing iterations are fetched from external computer communications, storage, or memory and compared against the corresponding current signature or signatures 705 using any technique in standard practice. In typical embodiments, the block and step at the identical subdivision and step sequence or iteration index from the immediately prior cycle is the target of the signature check, but any block and step signature may be checked as dictated by the application domain or embodiment, including prior blocks and steps from the current cycle if such blocks are likely to match signatures with the current block and step being processed. Subsequent processing operations are then selected based on the result of the comparison 706. If a signature matches, the corresponding prior block's result is fetched from external computer communications, storage, or memory 707, the below described processing operations 708, 709, 710, 711 and 712 and any remaining steps for the current block are skipped, avoiding associated computational costs. Candidate prior block results may be selected from the current or prior block cycle depending on the problem domain without substantially changing the embodiment. If no match is found, the current signature is stored in external computer communications, storage, or memory 708, the current cycle's processing is performed 709. A comparison 710 is performed to determine if the last temporal step of the current block's processing is complete. If so, the block's result is stored 712 in external computer communications, storage, or memory for use by future processing iterations. In alternate embodiments, the output signature may be stored concurrently with or subsequent to output result storage. If further processing operations remain, the step iterator K is incremented to the next processing operation and operation continues with step signature generation 704. In alternate embodiments the sequence of steps to be performed form a pipeline of discrete processing operations instead of using the step iterator K, in which case units 703 and 711 are omitted and units 705, 706, 708, 709 and 710 are replicated explicitly for each step. Once the signature decision 706 and all processing operations for the current block are complete, the block result is output to whatever subsequent processing the particular embodiment requires 713. A comparison 714 is then performed to determine if further blocks remain to be processed for the current cycle. If blocks remain to be processed, the iterator N is incremented to select the next block 715 and operation continues starting with reading the next block input 702. If no further blocks remain, the cycle is complete and the next cycle is started at 700. Embedding the example block and temporal step subdivision embodiment of FIG. 7 into a larger processing apparatus and determining under which conditions processing cycles begin and end may use any method available to someone skilled in the art without substantial change to the scope or usefulness of the embodiment, and the scope of the claimed subject matter is not limited in these respects.

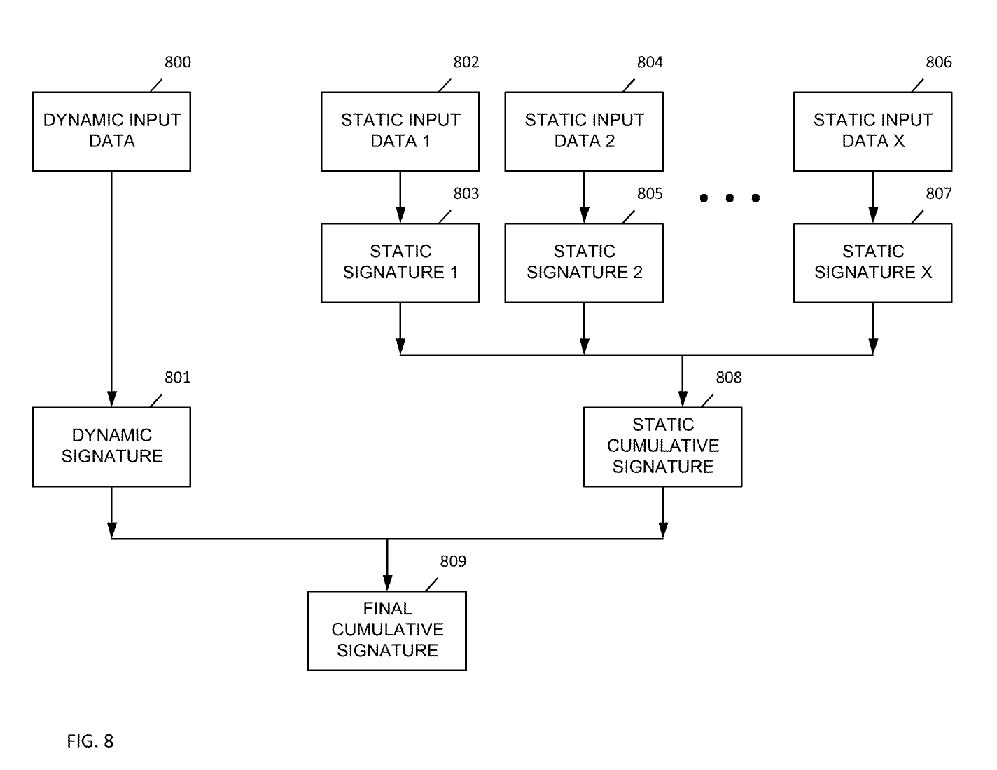

Referring now to FIG. 8, a diagram depicting an example of combined static and dynamic signature generation data flow for recurrent computation in accordance with one or more embodiments will be discussed. In some applications, part of the input stream may be amenable to signature pre-calculation rather than calculation during input processing. Such input data may be considered static or unchanging during one or more processing cycles, as opposed to dynamic input data which changes from cycle to cycle. Input data may change status from static to dynamic or dynamic to static based on operations performed by external processing operations, for example (but not limited to) modification by a central processing unit. Examples of static input data include (but are not limited to) bitmap or texture data being used in two-dimensional (2D) or three-dimensional (3D) graphics rendering, encoded video data prior to video stream decompression, or numeric buffers being used in streaming computations. Recalculating signatures for these static inputs on each input cycle may be redundant. Therefore the signature may be pre-calculated prior to the start of the processing cycle. These pre-calculated signatures may then be incorporated into the input signature of a given cycle as proxies for the underlying data by treating the sub-signatures themselves as part of the input data for which the new signature is being generated. FIG. 8 depicts the combination of static and dynamic signatures for an example embodiment of the claimed subject matter. Dynamic input data 800 is used to generate a dynamic signature 801, while static inputs 802, 804 and 806 have pre-calculated static signatures 803, 805 and 807 stored in associated external computer communications, storage, or memory. Determining which static inputs are in use in the current cycle can be performed during the dynamic signature generation step or during a separate pass through the dynamic input data. All referenced static inputs have their static signatures 803, 805, 807 combined into a cumulative static signature 808. This cumulative static signature 808 is then combined with the dynamic signature 801 to produce a final cumulative signature 809 which represents the combined static and dynamic inputs of the current processing operation. Alternate embodiments may involve feeding static signatures into the dynamic signature generation process by treating static signatures as proxies for the static data. Yet other embodiments may incorporate the static data streams directly into the dynamic signature generation itself, for example during the first reference to a static input data stream. Finally, any combination of pre-calculated and dynamically calculated signatures may be incorporated in any order in still other embodiments of the claimed subject matter. In addition to combining techniques from these various embodiments, an embodiment may keep more than one signature from a combination of static and dynamic data streams and utilize multiple signature comparators to detect matches or partial matches with prior cycle's signatures, and the scope of the claimed subject matter is not limited in these respects.

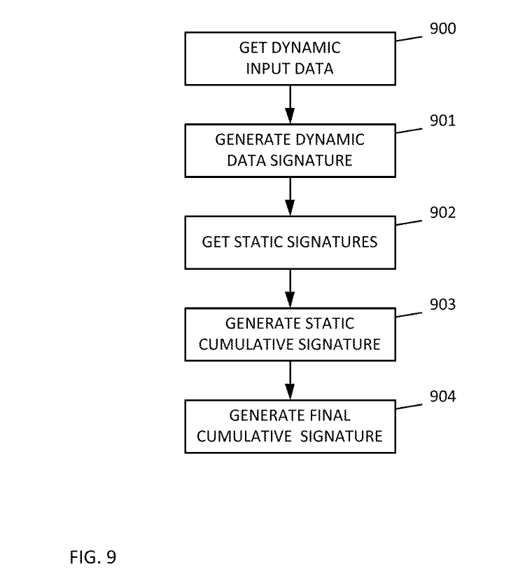

Referring now to FIG. 9, a flow diagram illustrating a process of combing static and dynamic signatures utilized with recurrent computation in accordance with one or more embodiments will be discussed. Operation begins when dynamic input data is fetched from external computer communications, storage, or memory and examined for references to static input data blocks utilized elsewhere in the overall processing of the recurrent computation cycle 900. The dynamic input data is used to generate a dynamic signature 901, omitting the contents of the detected static data references. For each referenced static data reference, an associated static signature is fetched from external computer communications, storage, or memory 902. Each static signature is then combined into a cumulative static signature 903. Finally, the overall cumulative signature is generated by combining the dynamic and static signatures 904 and operation ends. Alternate embodiments may incorporate said static signatures directly into the dynamic input stream either at the time the dynamic input data is generated, or during processing of the dynamic input data, and the scope of the claimed subject matter is not limited in these respects.

Signatures may be generated with a sufficiently large cyclic-redundancy check (CRC) or other hashing function capable of reducing the data footprint to a manageable finite quantity of information. There exist many such functions commonly known to those of skill in the art. However, the claimed subject matter is not limited to any particular such function. In addition to hashing, perceptual information such as average pixel value, DC frequency term, or format and size information may be incorporated into the signature to prevent perceptually disturbing false reuses of prior results from occurring.

In one embodiment the claimed subject matter may be used in conjunction with a two-dimensional (2D) or three-dimensional (3D) graphics pipeline. In this embodiment, the input stream consists of a series of drawing commands and associated bitmap buffer data which are processed into a final 2D image. The embodiment processes 2D and 3D drawing commands by subdividing the output image using a regular grid of rectangular regions and processing said regions independently using one or more local rendering buffers using a technique commonly referred to as a tiling or binning architecture. Each region has an associated input drawing command stream subdivided from the main input command stream by analyzing the screen region corresponding to each command and storing a copy of the command in each region's individual stream. In this embodiment, a frame of graphics commands corresponds to a processing cycle and is defined as the interval at which drawing results are displayed on an output device or written to a communications, storage or memory for subsequent use. Each region, typically referred to as a chunk or a tile, corresponds to a subdivided block of processing. The vertex and pixel processing stages may correspond to the steps in a block and step embodiment. At the completion of the subdivision of the input for a frame, typically called binning the command stream, each of the tiles may be processed independently utilizing one or more local high-speed buffers and the resulting buffers written to the final result stored in main memory. This embodiment generates a signature for each tile's input stream and an output signature associated with each output frame's buffered data from each tile, storing an array of signatures for both input and output signatures in memories associated with each output frame. If the tile's input signature matches the prior input signature stored with a particular output frame, tile command processing is avoided, and the prior frame's results are left unchanged if rendering is being performed in-place, or are copied from a prior result buffer. If the tile's input signature fails to match, tile command processing is performed and the generated output signature is checked, avoiding the final data write operation in tiles where the output signature matches. Alternate embodiments may employ either input or output signature matching alone, and the scope of the claimed subject matter is not limited in these respects.

In another embodiment of the above 2D or 3D graphics pipeline, the output buffer also has a signature performed on the contents of the buffer after command processing for a region completes. If this secondary signature matches the secondary signature stored with the output frame, the writing of the image data to the final output result buffer may be avoided even when the input command stream signatures fail to match. In this case processing was performed for the region, but the potentially expensive write to main memory was avoided.

In one embodiment, the claimed subject matter may be used in conjunction with a scalable vector graphics pipeline. This embodiment is substantially identical to the 2D graphics pipeline but may have additional capabilities targeted at rendering scalable 2D graphics.

In one embodiment, the claimed subject matter may be used in conjunction with a video decoding pipeline. In this embodiment, signatures of compression macro-blocks are stored and compared in order to avoid processing related to decoding the video data. In addition, on-chip decoding buffers may have signatures computed in order to avoid writing final pixel values to main memory.

In one embodiment, the claimed subject matter may be used in conjunction with a camera image processing pipeline. In this embodiment, some number of scan-lines of real-time input are buffered into inexpensive on-chip memory. These buffers are subdivided into rectangular tiles, and signatures are generated for each tile and compared against a prior frame's signatures. Tiles which match the signature of the prior frame are omitted from any further processing.

In one embodiment, the claimed subject matter may be used in conjunction with a streaming computation pipeline. In cases where no feedback paths between parallel computations are present, inputs to the pipeline, including all mathematical constants and state, have a signature computed. Some number of prior computation's results are tracked with a hash table indexed by their signatures. If the current input signature matches a prior result, the prior result is substituted and computation may be avoided for the input.

One possible implementation of the claimed subject matter is in conjunction with a binning or tile-based 3D graphics processor. Generally, a 3D graphics processor converts a sequence of drawing commands consisting of geometric shapes, typically 3 or 4 dimensional triangles, points and lines, into a two-dimensional representation on a regular grid of picture element values or pixels, typically called a raster or bitmap image. Typical uses for 3D graphics processing include rendering a sequence of views in temporal order to create the appearance of a viewpoint into a three-dimensional space on a two-dimensional display device such as a computer monitor. Rendering this sequence of views corresponds to the recurrent cyclical processing as discussed herein.

A binning or tile-based 3D graphics processor is one possible embodiment of a 3D graphics processor which subdivides the raster image to be produced into a regular grid of rectangular tiles such that each tile may be processed independently utilizing fast local memory to hold one or more tile's worth of intermediate data. This processor may be embodied as software, hardware including appropriate hardware circuits, or some suitable combination of both software and hardware.

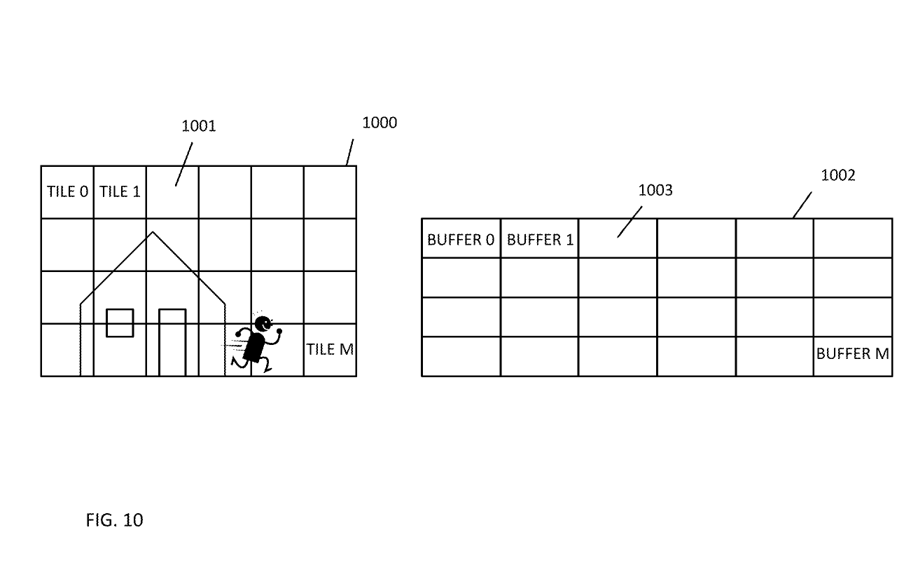

Referring now to FIG. 10, a diagram depicting an image subdivided buy a regular rectangular tiling, and a corresponding tile buffer memory in accordance with one or more embodiments will be discussed. FIG. 10 depicts an image, in this example a house and a running figure, subdivided by a regular rectangular tiling, and a corresponding tile buffer memory. The image 1000 is divided into tiles 1001 which may be indexed by their coordinates based on their spatial ordering. Corresponding to the conceptual image there is a physically realized array 1002 of buffers 1003 with storage corresponding to each respective tile. For the purpose of this description, said buffers may be considered as storage for either the sequence of input drawing commands relevant to each tile as sent as input to the 3D graphics processor, or as storage for the final pixel data produced by the 3D graphics processor during operation. Typical embodiments have separate storage for command and pixel tile buffers, though memory may be reused between operations in some embodiments, and the scope of the claimed subject matter is not limited in this respect.

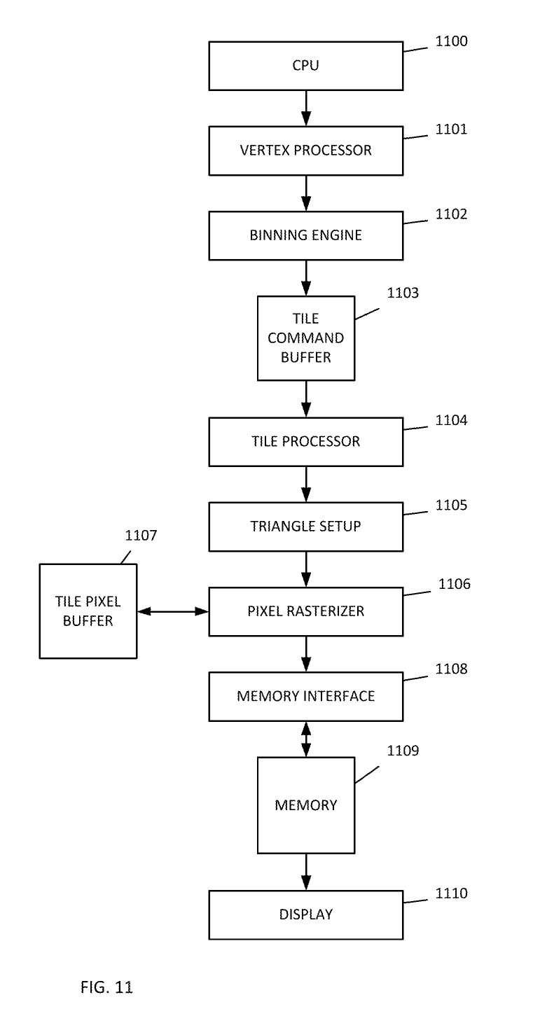

Referring now to FIG. 11, a block diagram of a tiling-based graphics processing engine in accordance with one or more embodiments will be discussed. FIG. 11 depicts a typical binning graphics processor that may be modified, adapted, or otherwise utilized in accordance with one or more embodiments. The graphics processor is controlled by a computer's central processing unit 1100 which issues drawing commands across a suitable interface to a vertex processor 1101. Drawing commands consist of both geometrical objects and rendering mode controls and data. Geometric objects typically represent points, lines, triangles or other geometric shapes described by vertex information consisting of spatial coordinates and optionally attributes such as color or texture coordinates to be interpolated across the pixels covered by the interior of the geometric object. Rendering mode commands describe in detail how the graphics processing should be performed by the embodiment. Mode information may consist of controls for fixed-function processing operations, references to or directly embedded data resources used during processing, such as texture image data, or it may be one or more programmatic instruction sequences, or shaders, used to control general purpose processing at any of the processing operations depicted in FIG. 11.

The vertex processor 1101 mathematically projects vertex positions from the typically higher-dimensional geometric space of the drawing commands down to a two-dimensional space suitable for rendering into a raster image to be displayed or reused in further graphics processing. In addition, the vertex processor 1101 may compute other attributes such as color, texture coordinates for texturing operations, or general programmatic attributes used in further pixel processing operations. Rendering in this case refers to the process of determining which output pixels in the image being drawn correspond to which visible geometrical object or objects in the input command stream, and then determining what color, depth or other attributes correspond to said pixel based on the graphics processor's capabilities and current mode of operation.

Once the vertex processor 1101 has transformed the input drawing commands to two-dimensional space, a binning engine 1102 sorts the commands and associated modes based on which tiled region or regions of the output screen they cover. Tiled regions are typically but not necessarily a grid subdividing the image being rendered into regular rectangular areas addressable by their X, Y coordinates corresponding to their spatial ordering. These sorted commands are stored in per-tile command buffer memories 1103 associated with each screen region or tile for later processing in a separate and potentially parallel tile processing phase 1104. The memories 1103 may be embodied as dedicated storage, fixed-sized regions of memory 1109, variable length mappings or lists of dedicated storage or memory 1109, or other implementations suitable for accommodating the sorted commands. An important feature of whichever embodiment is chosen is that the tile command buffers may be incrementally written due to the fact that the input command stream may cover regions of the image to be rendered in random order. To facilitate this incremental write ability, this embodiment maintains a set of tile buffer descriptors which describe the location of each tile buffer and the offset to the next available write location. This descriptor set may be embodied as either dedicated storage, an external table in memory 1109, or some other form of X, Y array addressable storage.

A separate tile processing unit 1104 selects each region's binned command stream for processing. The tiles may be selected in any single-traversal ordering since each tile's command buffer is independent of the others; tiles may also be processed in parallel by multiple instantiations of the tile processor 1104 and subsequent processing units. The tile processing phase may also be sequential with respect to the binning phase if limited tile command buffer 1103 space is available, or parallel if sufficient buffer space is available to permit two frames of graphics drawing commands to be stored at the same time. The tile processor 1104 reads each tiled region's geometric objects and mode information and passing drawing commands to a setup unit 1105 where the rasterization parameters such as edge equations and interpolated attribute pixel stepping values are computed for each geometric object in the tile. In addition, geometry which cannot contribute to the final image, for example because it faces away from the viewpoint or is completely outside of the region covered by the tile being rendered, may be removed, or clipped, from the processing stream by the setup unit 1105. Once the geometric object has been accepted for rendering and the computed parameters are ready, they are passed on to a rasterization unit 1106.

The rasterization unit 1106 steps through each pixel on the interior of each geometric object in the tile command stream and performs any per-pixel processing operations as indicated by the current mode settings. There are many different known techniques for determining which pixels are on the interior of the geometric object, and any such technique may be suitable for one or more embodiments. Once each pixel covered by the geometric object is determined, pixel processing may include execution of an arbitrary program, typically referred to as a pixel shader, or simply may be a sequence of fixed-function processing operations controlled by mode settings from the input command stream. In either case there, may be ancillary memory buffers associated with the image such as pixel color, pixel depth from the eye-point or projective plane, stencil information, or other user-defined attributes used in programmatic processing operations. Pixel processing accesses a local tile pixel memory 1107 for all intermediate pixel processing operations, only reading initial values from, and writing final results to, the memory interface 1108. These buffers are typically but not necessarily embodied as local on-chip memories with faster access times, lower power usage, higher bandwidth or combinations of other advantageous performance characteristics than is available from memory 1109. The tiling graphics processor gains its performance advantage from the locality and speed of the tile pixel memory 1107 compared to memory 1109.

The memory interface 1108 communicates with memory 1109 which contains the resulting image for use elsewhere in the system, either as a display output 1110 or as texture or other image input for further rendering steps (not shown). In typical embodiments, the local tile pixel memory 1107 may be double-buffered to allow transfers to memory 1109 to occur in parallel with ongoing pixel rendering from subsequent tiles.

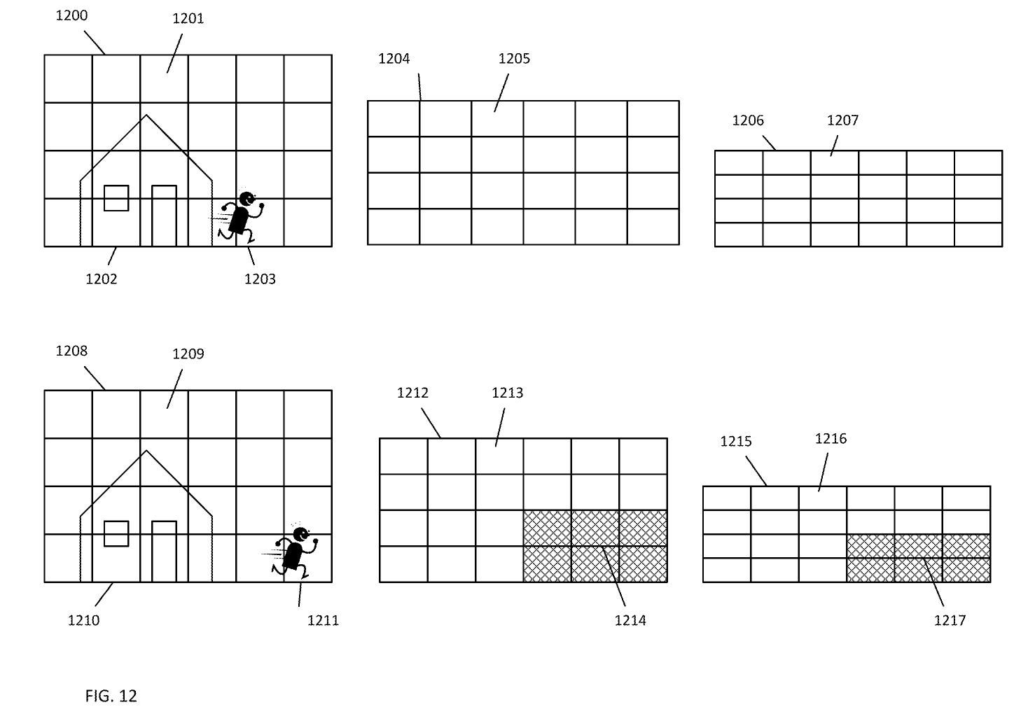

Referring now to FIG. 12, a diagram depicting an image subdivided buy a regular rectangular tiling, a corresponding tile buffer memory, and a corresponding signature memory for example optimized embodiments of a graphics processor in accordance with one or more embodiments will be discussed. FIG. 12 depicts two representative frames from a typical 3D graphics rendering application. The frames 1200, 1208 represent two cycles of the recurrent processing of a sequence of frames which the hypothetical example application wishes to display. The frames are divided into rectangular regions or tiles 1201, 1209 which remain in the same X, Y locations relative to the overall image for each processing frame. In this example, an image of a house 1202, 1210 remains static while an image of a running figure 1203, 1211 moves from frame to frame. Corresponding to the images there are tile buffer memories 1204, 1212 with X, Y array addressable tile contents 1205, 1213 which can represent either storage for a sequence of drawing commands binned by a binning graphics processor, or storage for pixel tiles processed by the pixel processing operation in said processor. In this embodiment, a signature memory 1206, 1215 may be associated with per-tile signatures 1207, 1216 such that each cell in the signature memory is addressed with the same X, Y coordinate as the corresponding tile in the original image 1200, 1208. In the case of drawing commands, the signatures are formed from the command stream data as it is written to each tile command buffer. In the case of pixel data, the signatures are formed from the pixels within the final pixel tile as they are being written to memory. The signature memory 1206, 1215 may be a dedicated resource, a region of main memory, or some other storage device suitable for random addressing by X, Y coordinate. In particular these signatures may be incorporated or embedded into other data structures used in various embodiments of the claimed subject matter, such as the tile command buffer memory 1205, 1213.

In this particular example, only the cells corresponding to the shaded area 1214 result in different signatures between the two frames 1200 and 1208. As a result, the claimed subject matter would be able to eliminate processing associated with the complementary unshaded signatures in signature memory 1212. This saving can be realized either at the tile command processing operation if the signatures refer to binned commands or at the write-out phase of the pixel processing operation if the signatures refer to tile pixel buffers.

In addition to generating per-tile signatures for pixel images (1204, 1212), an overall master signature for the contents of the completed signature memories themselves may be generated and associated with the drawn image. This master signature may be generated in the same manner as the constituent signatures themselves, using the contents of signature memory 1206, 1215 as the input to the signature generator. This master signature can then be incorporated into the input command stream signature of subsequent drawing cycles in cases where the command steam references image or other out-of-line data as part of its input data stream. Such references may happen when rendered images are used as texture or other input data to subsequent rendering cycles. This master signature generation may also be performed by software or dedicated hardware for images which are sourced from the application directly, for example texture images stored as static data in the application itself. However, the scope of the claimed subject matter is not limited in these respects.

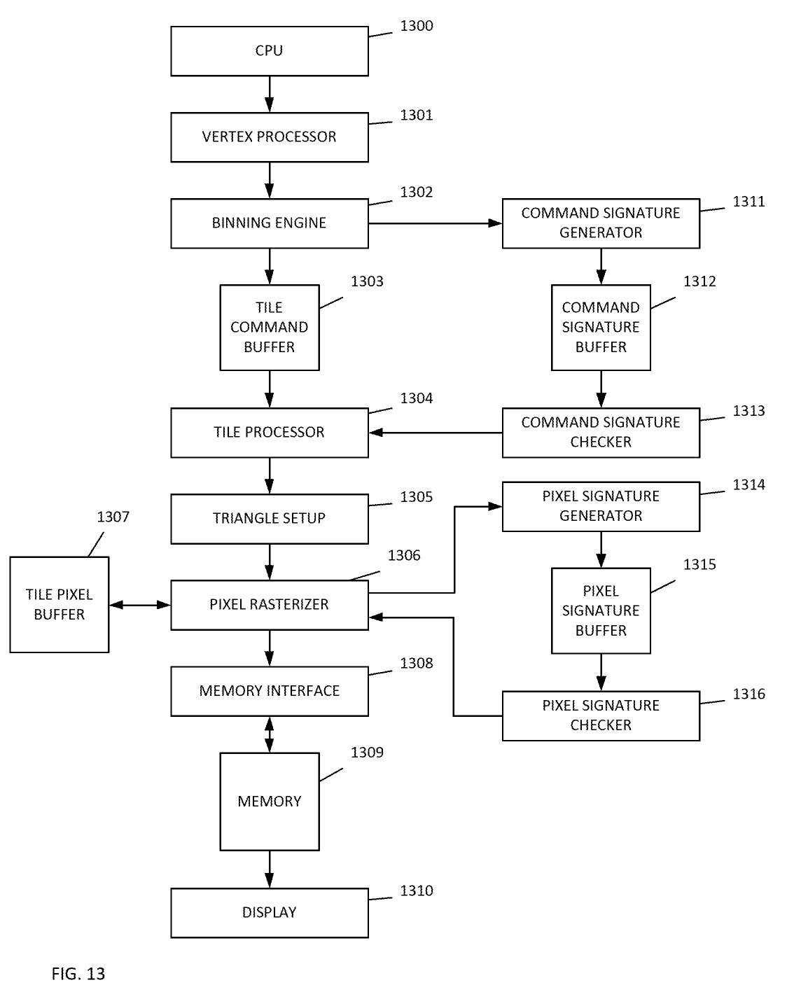

Referring now to FIG. 13, a block diagram of a tiling-based graphics processing engine in accordance with one or more embodiments will be discussed. FIG. 13 shows a block diagram of an embodiment integrated into a binning graphics processor. The descriptions of the central processing unit 1300, vertex processor 1301, binning engine 1302, tile command buffer 1303, tile processor 1304, triangle setup 1305, pixel rasterizer 1306, tile pixel buffer 1307, memory interface 1308, memory 1309 and display 1310 correspond to the descriptions of FIG. 11 items 1100-1110, with exceptions or changes as indicated in the following paragraphs.

As this embodiment's binning engine 1302 sorts drawing commands such as geometric objects and mode settings into each tile's associated tile command buffer 1303, it additionally generates a signature 1311 for each tile's command stream. Since individual tile command buffers may be visited many times in the course of sorting one input cycle of commands due to the fact that geometry may be distributed randomly across image tiles when viewed from the input command sequence's ordering, the signature generation technique selected must therefore be able to store partial signature generation state if output to a particular tile buffer temporarily halts, and restore said state to the signature generation logic when output to that tile's buffer resumes. This may be accomplished by additional dedicated storage for each tile's signature generation state in a command signature buffer 1312. Embodiments may include on-chip memories or external memory storage for command signature buffer 1312 depending on performance, cost or other constraints. Caching using any suitable technique may also be employed by an embodiment in order to enhance access performance to the command signature buffer 1312. Alternate embodiments may reserve space for signature generation state in the data structure describing each tile's buffer. Yet other embodiments may generate signatures 1311 in a separate post-binning processing operation wherein each bin's data is explicitly traversed for the purpose of signature generation. One attribute for the embodiment of the selected signature generation technique is therefore that the intermediate state associated with signature generation should be compact enough to be stored temporarily with each tile's command buffer as the command sorting process progresses.

This embodiment includes a command signature check unit 1313 which optionally reads and compares signatures from the prior frame's tile command buffer descriptors if the prior frame's descriptors are available. If the prior frame's signatures are available, the command signature check unit 1313 compares signatures for each tile in the current and previous frame, discarding tiles which match from further processing and passing tiles which fail to match on to the tile processor 1304. If no prior signatures are available, all or nearly all tiles are passed on to the tile processor. Alternate embodiments may retain and compare against multiple frames of command signatures, for example during triple or higher buffering of frames, or may compare against prior tiles' command signatures in the current frame.

This embodiment's rasterization unit 1306 passes pixel transactions to the tile pixel buffer 1307 and also to a new pixel signature generation unit 1314. A pixel signature buffer 1315 stores partial signature state as transactions are processed. Transactions to the tile pixel buffer include buffer read and write operations for individual pixels as well as buffer load and store commands which initiate transfers from or to memory 1309 buffers. Upon completion of the command buffer for a given tile, the pixel signature check unit 1316 compares prior cycle's signatures before the tile pixel buffer 1307 contents are sent to the memory interface 1308 to be written to memory 1309.

This embodiment includes a pixel signature check unit 1316 which optionally reads and compares signatures from the image's signature table if the image signatures are available for a prior frame. The relevant data structures are depicted in FIG. 12 as an example. If the signatures are available, the pixel signature check unit 1316 compares the newly generated signature for the tile pixel buffer 1307 and the corresponding image signature table entry at the same X, Y coordinate as the current tile being written, discarding writes to memory 1309 for signatures which match and passing signatures which fail to match on to the memory interface 1308. If no prior signatures are available all writes are passed on to the memory interface 1308. Alternate embodiments may choose to retain and compare against multiple frames of pixel signatures, for example during triple or higher buffering of frames, or choose to compare against prior tiles' pixel signatures in the current frame.

An alternate embodiment places the signature generation unit 1314 between the tile pixel buffer 1307 and the pixel signature check unit 1316, only performing signature generation when the rendering is complete and the tile contents are to be written to memory 1309. This alternate configuration may be utilized in cases where tile pixel data is processed prior to writing to memory 1309, for example during anti-aliasing image filtering operations.

Once rendering is complete, images may be sent to a display unit 1310 or used in subsequent rendering steps as detailed in FIG. 11. Due to the nonzero possibility of false matches in the command signature check unit 1313 and pixel signature check unit 1316, both units may include fail-safe modes controllable by software to prevent their respective optimizations from being performed, suppressing the behavior of the additional subject matter, and allowing this embodiment to perform identically to the operation described in FIG. 11.

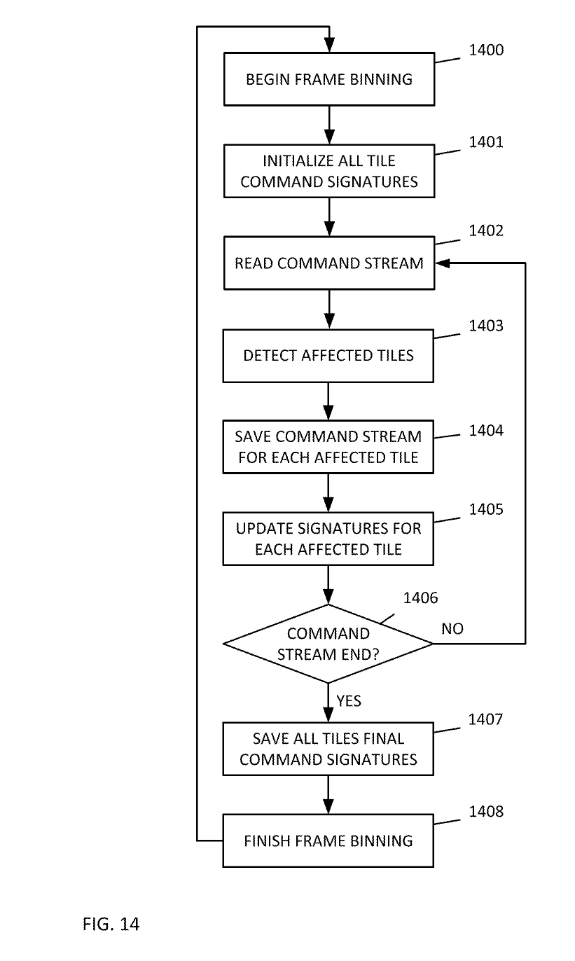

Referring now to FIG. 14, a flow diagram illustrating the operation of an example optimized embodiment of a tiling-based graphics processing binning processor in accordance with one or more embodiments will be discussed. FIG. 14 illustrates the operation of the embodiment in a binning graphics processor's binning processor. It is assumed that the loop shown in FIG. 14 is entered at the beginning of a frame 1400 and exited after a final frame is rendered 1415, these entry and exit points have been omitted from the drawing for clarity. The binning processor subdivides a frame of input commands by screen region such that each tile's separated command stream will recreate an identical tile's worth of pixels after pixel rasterization when compared with a traditional sequential graphics processor embodiment. Frame invariant processing, typically initialization of rendering state involved in tracking mode changes throughout the processing of the input command stream, is performed at the start of the frame 1400. Signatures for the current frame are then initialized 1401 to a default initial value suitable for whatever signature generation technique has been selected for the embodiment. A command from the input command stream is then read 1402. If the command is a mode change from the current rasterization mode setting, the new mode is recorded and flagged for update. Such flagging may be embodied as a per-tile array of flags indicating a change has occurred along with storage for whatever current mode value is valid, or by any other technique which can be queried to ascertain whether the current rendering state vector for a given tile is different from the prior geometry's state at any point during input stream processing for a given tile.

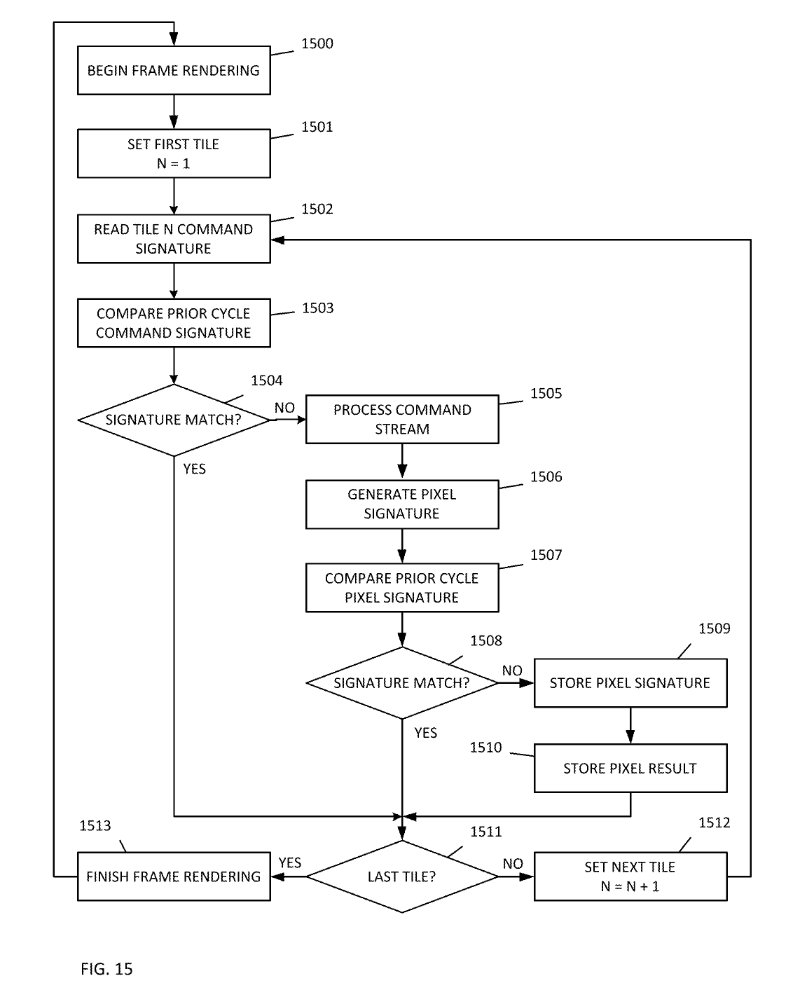

If the command is a new geometric draw command, affected tiles covered by the geometry may be determined 1403 using commonly known techniques, for example (but not limited to) simple bounding-box traversal and tile corner testing against the geometric edge equations. Then a respective tile's command stream may be updated with all or nearly all flagged mode changes and the new geometry command 1404, and the corresponding mode flags are cleared for that tile. Modes which change during the sequence of geometric drawing commands for a particular tile must be stored in each affected tile's command stream in order to recreate the correct sequence of operations when the tile's command stream is subsequently rendered into the tile pixel buffer during the pixel rasterization step. In the course of updating each tile's command stream, the associated tile signature may be incrementally updated to account for the new command data 1405. Alternate embodiments may postpone signature generation until all input commands from the current frame of the input command stream are processed. If the input command stream has still further commands to process, operation continues at the command stream reading step 1402. If all commands for the current frame are complete, the final tile command stream signatures must be stored in a memory associated with each tile's command buffer 1407. At this point, any final binning processing, such as initiating tile pixel processing, may be optionally performed 1408, and the frame is considered complete from the binning processor's point of view. Further frames may then be processed, potentially but not necessarily in parallel with ongoing tile pixel rasterization processing as illustrated in FIG. 15.

Referring now to FIG. 15, a flow diagram illustrating the operation of a tiling-based graphics processing pixel rasterizer in accordance with one or more embodiments will be discussed. The method of FIG. 15 illustrates one particular embodiment the operation of a binning graphics processor's tile rendering processor. However, in one or more alternative embodiments, various other orders of the blocks of the method of FIG. 15 may be implemented, with more or fewer blocks, and the scope of the claimed subject matter is not limited in this respect. It is assumed that the loop shown in FIG. 15 is entered at the beginning of a frame 1500 and exited after a final frame is rendered 1513, these entry and exit points have been omitted from the drawing for clarity. Operation begins with frame invariant processing, typically initialization of pixel rasterizer rendering state, performed at the start of the frame 1500. A tile iterator N is initialized to select a first tile for processing 1501. This example iterates through the tiles in linear order, however any tile iteration scheme, such as following a Hilbert curve or using hierarchical clustering, is acceptable as is commonly known. For each tile the current tile command stream signature is read 1502, and if available, a prior command stream signature is fetched from the same X, Y coordinates as the current tile and compared against the current tile's command signature 1503. If there is a prior signature and the current and prior signatures match 1504, no further processing is required for the current tile and operation continues at the last tile check 1511, saving the remaining associated tile processing costs. If there is no prior signature or the command stream signature fails to match, the current tile's command stream is processed 1505 and a pixel signature is generated 1506 from the corresponding pixel transactions. Alternate embodiments may defer tile pixel signature generation until the end of the tile's pixel rasterization, traversing pixels prior to writing the final pixel values to memory in order to generate the tile pixel signature. When all commands from the current tile have been processed, the prior pixel signature, if available, is fetched from the prior image's signature table and compared against the generated pixel signature 1507. If the signatures match 1508, no further processing is required for the current tile and operation continues at the last tile check 1511, saving the remaining associated tile processing costs. If the pixel signatures fail to match, the newly generated pixel signature is stored in the current frame's pixel signature table 1509 and the pixel result buffers are stored in external communication channels, storage or memory 1510. At this point all variant processing for the given tile is complete, and a determination is made as to whether there are further tiles to be processed 1511. If the last tile has been processed, any operations associated with frame completion are performed 1513 and any subsequent frames may begin their pixel rasterization at step 1500. If there are further tiles to be processed in the current frame, the tile iterator N is incremented and processing continues with the reading of the next tile's command stream 1502. If no further frames remain to be processed, operation ends. Embedding the example binning processor embodiment of FIG. 14 and the tile rendering processor embodiment of FIG. 15 into a larger processing apparatus and determining under which conditions frame processing begins and ends may use any method available to someone skilled in the art without substantial change to the scope or usefulness of the embodiments, and the scope of the claimed subject matter is not limited in this respect.

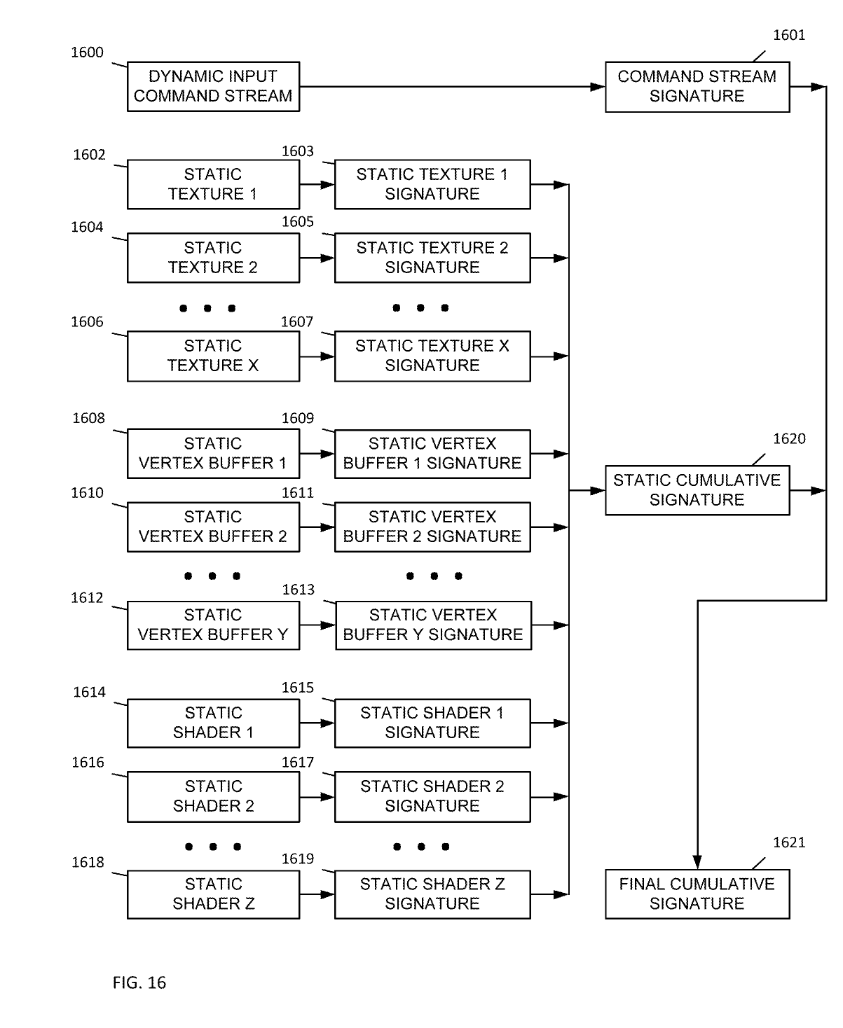

Referring now to FIG. 16, a diagram depicting a combination of dynamic and static signatures into a master signature for a graphics command sequence utilized by a graphics processor in accordance with one or more embodiments will be discussed. FIG. 16 depicts the combination of dynamic and static signatures into a master signature for a graphics command stream in a binning graphics processor embodiment. While this embodiment depicts a combination of all static signatures into one cumulative signature, any combination of incorporating static signatures directly into the dynamic command stream signature or utilizing multiple signatures and comparators is functionally identical to this embodiment. The dynamic input command stream portion of the input data 1600 is typically generated by, but not limited to, a software application executing on a central processing unit. This dynamic input is input which changes for each frame being processed. Incorporated by reference through pointers or indexes into tables of rendering resource descriptors or other indirect referencing techniques are one or more static input data sources, such as textures 1602, 1604, 1606, vertex buffer data 1608, 1610, 1612, shader programs 1614, 1616, 1618, or other frame-invariant data resources utilized while processing the input command stream. Rather than redundant traversal of said static input data sources during signature generation, one or more static data signatures 1603, 1605, 1607, 1609, 1611, 1613, 1615, 1617, 1619 are associated with each static data input. This embodiment stores such static signatures in the data descriptors for each static input data object, but any other method of associating the signatures with the static data inputs is also acceptable. These static signatures may be pre-computed at the time the static data inputs are defined, saving signature computation costs on each frame in which the static data inputs are utilized. In addition, data inputs may transition from static to dynamic or dynamic to static status based on the frequency of modification by external agencies, for example by application execution on a central processing unit, relative to the frequency of their usage within each frame being rendered. Computation of static signatures may be performed by any combination of software executing on a central processing unit (CPU) or dedicated signature generation apparatus. The static signature generation technique may be identical to the technique utilized by the dynamic signature generation embodiment; alternately any suitable signature generation technique, for example a technique with lower probability of collision, may be utilized.

Once the total input command stream for a frame is known, typically at a frame boundary, the signatures for all static resources utilized in the frame may be combined into a cumulative static signature 1620. This cumulative static signature is then combined with the dynamic command stream signature 1601 to provide a final cumulative stream signature 1621. Alternate embodiments may incorporate each static data input's signature into the overall command stream signature 1601 as each utilization of a static data input is encountered in the dynamic input command stream, in which case the command stream signature 1601 is utilized as the final cumulative stream signature 1621 directly. In either case the order of reference must be preserved during signature generation so that the overall signature uniquely and correctly identifies the combination of static and dynamic commands to be executed as compared with other possible execution orderings, and the scope of the claimed subject matter is not limited in these respects.

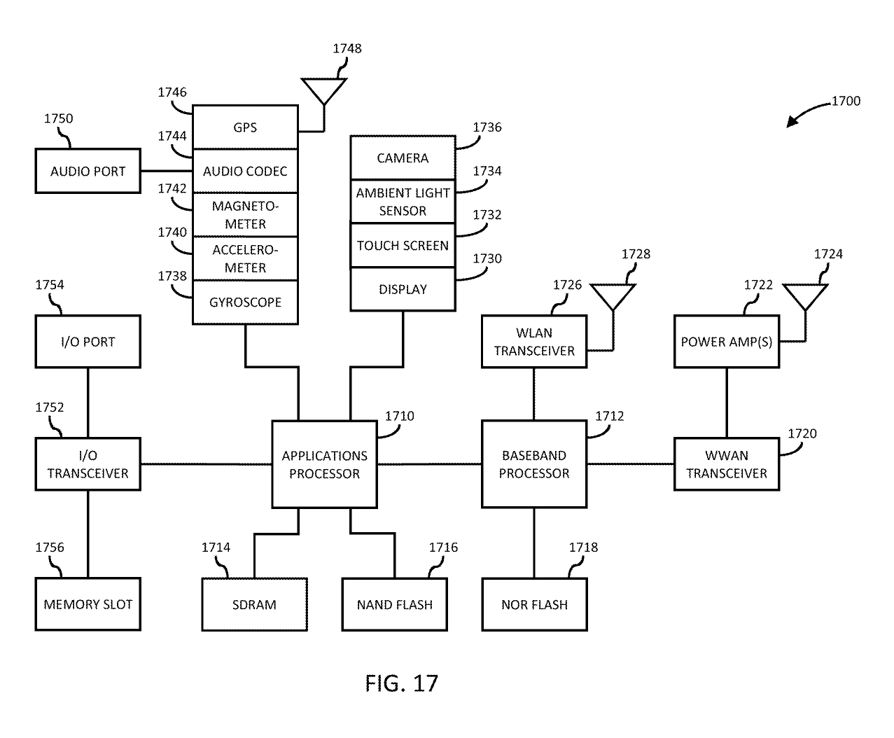

Referring now to FIG. 17, a block diagram of an information handling system capable of reducing recurrent computation cost in a data processing pipeline in accordance with one or more embodiments will be discussed. Information handling system 1700 of FIG. 17 may tangibly embody one or more of any of the embodiments described herein, either in hardware and/or in software running on information handling system 1700. Although information handling system 1700 represents one example of several types of computing platforms, such as a smartphone, tablet, hand held gaming device, or the like, information handling system 1700 may include more or fewer elements and/or different arrangements of elements than shown in FIG. 17, and the scope of the claimed subject matter is not limited in these respects.

In one or more embodiments, information handling system 1700 may include an applications processor 1710 and a baseband processor 1712. Applications processor 1710 may be utilized as a general purpose processor to run applications and the various subsystems for information handling system 1700. Applications processor 1710 may include a single core or alternatively may include multiple processing cores wherein one or more of the cores may comprise a digital signal processor or digital signal processing core. Furthermore, applications processor 1710 may include a graphics processor or coprocessor disposed on the same chip, or alternatively a graphics processor coupled to applications processor 1710 may comprise a separate, discrete graphics chip. Applications processor 1710 may include on board memory such as cache memory, and further may be coupled to external memory devices such as synchronous dynamic random access memory (SDRAM) 1714 for storing and/or executing applications during operation, and NAND flash 1716 for storing applications and/or data even when information handling system 1700 is powered off. Baseband processor 1712 may control the broadband radio functions for information handling system 1700. Baseband processor 1712 may store code for controlling such broadband radio functions in a NOR flash 1718. Baseband processor 1712 controls a wireless wide area network (WWAN) transceiver 1720 which is used for modulating and/or demodulating broadband network signals, for example for communicating via a Third Generation (3G) or Fourth Generation (4G) network or the like or beyond, for example a Long Term Evolution (LTE) network. The WWAN transceiver 1720 couples to one or more power amps 1722 respectively coupled to one or more antennas 1724 for sending and receiving radio-frequency signals via the WWAN broadband network. The baseband processor 1712 also may control a wireless local area network (WLAN) transceiver 1726 coupled to one or more suitable antennas 1728 and which may be capable of communicating via a Wi-Fi, Bluetooth, and/or an amplitude modulation (AM) or frequency modulation (FM) radio standard including an IEEE 802.11a/b/g/n standard or the like. It should be noted that these are merely example implementations for applications processor 710 and baseband processor 1712, and the scope of the claimed subject matter is not limited in these respects. For example, any one or more of SDRAM 1714, NAND flash 1716 and/or NOR flash 1718 may comprise other types of memory technology such as magnetic memory, chalcogenide memory, phase change memory, or ovonic memory, and the scope of the claimed subject matter is not limited in this respect.

In one or more embodiments, applications processor 1710 may drive a display 1730 for displaying various information or data, and may further receive touch input from a user via a touch screen 1732 for example via a finger or a stylus. An ambient light sensor 1734 may be utilized to detect an amount of ambient light in which information handling system 1700 is operating, for example to control a brightness or contrast value for display 1730 as a function of the intensity of ambient light detected by ambient light sensor 1734. One or more cameras 1736 may be utilized to capture images that are processed by applications processor 1710 and/or at least temporarily stored in NAND flash 1716. Furthermore, applications processor may couple to a gyroscope 1738, accelerometer 1740, magnetometer 1742, audio coder/decoder (CODEC) 1744, and/or global positioning system (GPS) controller 1746 coupled to an appropriate GPS antenna 1748, for detection of various environmental properties including location, movement, and/or orientation of information handling system 1700. Alternatively, controller 1746 may comprise a Global Navigation Satellite System (GNSS) controller. Audio CODEC 1744 may be coupled to one or more audio ports 1750 to provide microphone input and speaker outputs either via internal devices and/or via external devices coupled to information handling system via the audio ports 1750, for example via a headphone and microphone jack. In addition, applications processor 1710 may couple to one or more input/output (I/O) transceivers 1752 to couple to one or more I/O ports 1754 such as a universal serial bus (USB) port, a high-definition multimedia interface (HDMI) port, a serial port, and so on. Furthermore, one or more of the I/O transceivers 1752 may couple to one or more memory slots 1756 for optional removable memory such as secure digital (SD) card or a subscriber identity module (SIM) card, although the scope of the claimed subject matter is not limited in these respects.

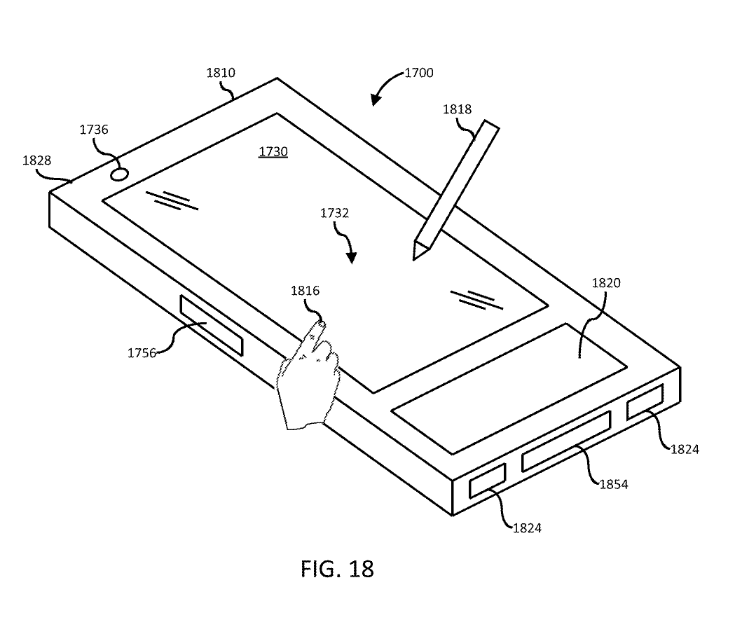

FIG. 18 is an isometric view of an information handling system of FIG. 17 that optionally may include a touch screen in accordance with one or more embodiments. FIG. 18 shows an example implementation of information handling system 1700 of FIG. 17 tangibly embodied as a cellular telephone, smartphone, or tablet type device or the like. The information handling system 1700 may comprise a housing 1810 having a display 1730 which may include a touch screen 1732 for receiving tactile input control and commands via a finger 1816 of a user and/or a via stylus 1818 to control one or more applications processors 1710. The housing 1810 may house one or more components of information handling system 1700, for example one or more applications processors 710, one or more of SDRAM 1714, NAND flash 1716, NOR flash 1718, baseband processor 1712, and/or WWAN transceiver 1720. The information handling system 1700 further may optionally include a physical actuator area 1820 which may comprise a keyboard or buttons for controlling information handling system via one or more buttons or switches. The information handling system 1700 may also include a memory port or slot 1756 for receiving non-volatile memory such as flash memory, for example in the form of a secure digital (SD) card or a subscriber identity module (SIM) card. Optionally, the information handling system 1700 may further include one or more speakers and/or microphones 1824 and a connection port 1754 for connecting the information handling system 1700 to another electronic device, dock, display, battery charger, and so on. In addition, information handling system 1700 may include a headphone or speaker jack 1828 and one or more cameras 1736 on one or more sides of the housing 1810. It should be noted that the information handling system 1700 of FIG. 18 may include more or fewer elements than shown, in various arrangements, and the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. It is believed that the subject matter pertaining to reducing recurrent computation cost in a data processing pipeline and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An article of manufacture comprising a storage medium having instructions stored thereon that, if executed, result in:
generating a current data signature based at least in part on current input data;
comparing the current data signature to a prior cycle data signature; and
if the current data signature at least partially matches the prior cycle data signature, fetching a prior cycle result and foregoing processing of at least part of the current input data.

2. An article of manufacture as claimed in claim 1, wherein data is divided into N blocks, said generating comprising generating a current data signature for block N, and said comparing comprising comparing the current data signature for block N to a prior data signature for block N.

3. An article of manufacture as claimed in claim 2, said fetching comprising fetching a prior cycle result, and said foregoing processing comprising foregoing processing of at least part of the current input data if the current data signature for block N at least partially matches the prior cycle data signature for block N.

4. An article of manufacture as claimed in claim 1, wherein data is divided into N blocks, and the N blocks are divided into K processing steps, said generating comprising generating a current data signature for block N and processing step K, and said comparing comprising comparing the current data signature for block N and processing step K to a prior data signature for block N and processing step K.

5. An article of manufacture as claimed in claim 4, said fetching comprising fetching a prior cycle result, and said foregoing processing comprising foregoing processing of at least part of the current input data if the current data signature for block N and processing step K at least partially matches the prior cycle data signature for block N and processing step K.

6. A method as claimed in claim 1, wherein the current data signature or the prior cycle data signature comprises a dynamic signature portion based at least in part on dynamic input data, or a static signature portion based at least in part on static input data, or combinations thereof.

7. An article of manufacture as claimed in claim 6, wherein the static signature portion is pre-calculated without requiring said generating for a given processing cycle.

8. An article of manufacture as claimed in claim 1, wherein the instructions, if executed, further result in:
dividing the current input data into two or more tiles;
said generating comprising generating a command signature for the two or more tiles and storing the command signatures in a respective tile command buffer; and
said comparing comprising comparing a command signature of a current input data tile command buffer with a command signature of a prior cycle tile command buffer.

9. An article of manufacture as claimed in claim 1, wherein the instructions, if executed, further result in:
processing pixel transactions for one or more pixels of the current input data;
said generating comprising generating a pixel signature for the one or more pixels and storing the pixel signatures in a pixel signature buffer; and
said comparing comprising comparing a pixel signature of a current data pixel signature buffer with a pixel signature of a prior cycle pixel signature buffer.

10. A graphics processor, comprising:
a data signature generator circuit to generate a current data signature based at least in part on current input data;
a compare circuit to compare the current data signature to a prior cycle data signature; and
a computation circuit to fetch a prior cycle result and forego processing of at least part of the current input data if the current data signature at least partially matches the prior cycle data signature.

11. A graphics processor as claimed in claim 10, further comprising:
a divider circuit to divide data into N blocks;
said data signature generator circuit being configured to generate a current data signature for block N; and
said compare circuit being configured to compare the current data signature for block N to a prior data signature for block N.

12. A graphics processor as claimed in claim 11, further comprising:
said computation circuit being configured to fetch a prior cycle result and forego processing of at least part of the current input data if the current data signature for block N at least partially matches the prior cycle data signature for block N.

13. A graphics processor as claimed in claim 10, further comprising:
a divider circuit to divide data into N blocks, and to divide the N blocks into K processing steps;
said data signature generator being configured to generate a current data signature for block N and processing step K; and
said compare circuit being configured to compare the current data signature for block N and processing step K to a prior data signature for block N and processing step K.

14. A graphics processor as claimed in claim 13, wherein the computation circuit is configured to fetch a prior cycle result and forego processing of at least part of the current input data if the current data signature for block N and processing step K at least partially matches the prior cycle data signature for block N and processing step K.

15. A graphics processor as claimed in claim 10, wherein the current data signature or the prior cycle data signature comprises a dynamic signature portion based at least in part on dynamic input data, and a static signature portion based at least in part on static input data.

16. A graphics processor as claimed in claim 15, wherein the computation circuit is configured to pre-calculate the static signature portion without requiring generation of the static signature portion for a given processing cycle.

17. A graphics processor as claimed in claim 10, further comprising:
a tile processor circuit to divide the current input data into two or more tiles;
a command signature generator circuit to generate a command signature for the two or more tiles and store the command signatures in a respective tile command buffer; and
a command signature checker circuit to compare a command signature of a current input data tile command buffer with a command signature of a prior cycle tile command buffer.

18. A graphics processor as claimed in claim 10, further comprising:
a pixel rasterizer to process pixel transactions for one or more pixels of the current input data;
a pixel signature generator circuit to generate a pixel signature for the one or more pixels and store the pixel signatures in a pixel signature buffer; and
a pixel signature checker circuit to compare a pixel signature of a current data pixel signature buffer with a pixel signature of a prior cycle pixel signature buffer.

19. An information handling system, comprising:
a baseband processor coupled to one or more wireless transceivers; and
an applications processor coupled to the baseband processor, wherein the applications processor is configured to:
generate a current data signature based at least in part on current input data;
compare the current data signature to a prior cycle data signature; and
if the current data signature at least partially matches the prior cycle data signature, fetch a prior cycle result and forego processing of at least part of the current input data.

20. An information handling system as claimed in claim 19, further comprising:
a tile processor circuit to divide the current input data into two or more tiles;
a command signature generator circuit to generate a command signature for the two or more tiles and store the command signatures in a respective tile command buffer;
a command signature checker circuit to compare a command signature of a current input data tile command buffer with a command signature of a prior cycle tile command buffer;
a pixel rasterizer to process pixel transactions for one or more pixels of the current input data;
a pixel signature generator circuit to generate a pixel signature for the one or more pixels and store the pixel signatures in a pixel signature buffer; and
a pixel signature checker circuit to compare a pixel signature of a current data pixel signature buffer with a pixel signature of a prior cycle pixel signature buffer.
